(19) United States
(12) Patent Application Publication
(10) Pub. No.: US 2008/0244019 A1
(43) Pub. Date: Oct. 2, 2008

(54) System and method for plug and play video-conferencing

(76) Inventors: Richard E. Mellor, San Carlos, CA (US); John Bateman, San Francisco, CA (US)

Correspondence Address: THE LAW OFFICE OF DEEPTI PANCHAWAGH - JAIN, C/O INTELLEVALE, PO BOX 52050, MINNEAPOLIS, MN, 55402, US

(21) Appl. No.: 11/731,618

(22) Filed: Mar. 30, 2007

(51) Int. Cl. G06F 15/16; H04N 7/14

(52) U.S. Cl. 709/206; 348/14.01; 726/9

(57) ABSTRACT

The present invention is a system and method for simply and intuitively establishing and using a communication link with another user. Various embodiments of the present invention allow one or more non-technically oriented users to also easily set up for, and engage easily in a video call. In an embodiment, a communication application used over a network (e.g., the Internet) is seamlessly downloaded onto a user's machine if necessary. The user is provided with an account which has already been created/registered with the application. In addition, the user's account is linked to at least one other account, and information for each account is populated into the buddy-list or contact information for the other account. Providing of already created/registered accounts, and the linking of various accounts, permits easy and seamless communication between users. In one embodiment, cards are used to provide the user with information regarding the pre-registered accounts.

### BACKGROUND OF THE INVENTION

1. Field of the Invention

This invention relates generally to easy and seamless communication between computer users, and more particularly, to an easy and seamless manner of video instant messaging.

2. Description of the Related Art

Over the past few years, contact established by people with each other electronically has increased tremendously. Various modes of communication are used to electronically communicate with each other, such as emails, text messaging, etc. In particular, Instant Messaging (IM), which permits people to communicate with each other over the Internet in real time (“IM chats”), has become increasingly popular.

Several IM programs are currently available, such as ICQ from ICQ, Inc., America OnLine Instant Messenger (AIM) from America Online, Inc. (Dulles, Va.), MSN® Messenger from Microsoft Corporation (Redmond, Wash.), Yahoo!® Instant Messenger from Yahoo! Inc. (Sunnyvale, Calif.), and Skype from Skype Technologies, S.A. (Luxemborg).

While these IM services have varied user interfaces, most of them work in the same basic manner. Each user is required to choose a unique user ID (the uniqueness of which is checked by the IM service), as well as a password. The user then has to log on from a machine on which the corresponding IM program is downloaded by using his/her user ID and password. To facilitate instant messaging, the user often also needs to specify a “buddy list” for which he needs to provide the userids and/or email addresses of the various other IM users with whom the user wishes to communicate.

Conventionally, when two users are logged in to an IM program, they can communicate with each other using text. More recently, IM programs also permits users to communicate not only using text alone, but also using audio, still pictures, video, etc. Such types of IMing (e.g., Video IMing) requires the users at the two ends to take even further steps, such as plugging in a webcam, downloading the appropriate software, starting the video conversation, etc.

Thus, despite the widely available video IM technologies, the complexity of initiating especially the first video calling and/or conferencing session with a novice peer is a stumbling block. It is currently a complex process to gather, install, and configure all components' necessary for a video conferencing session. As mentioned above, the caller must establish an identity in the system. In addition, it is difficult to know how to locate a peer (person who's identity is known to the caller) through the components of the video conferencing system. Once the peer is located it may still not be clear to the “caller” how to establish a video conferencing session with the peer. Further, often the peer is a novice and responsibility falls to the caller to first help the peer to get the system set up on their end and then guide them through the process of creating an identity in the system and accepting the prompt to initiate the video conferencing session.

To reiterate, numerous steps need to be taken by a user before he can effectively be involved in a VIM conversation with another user. For instance, the user has to:

(i) obtain a webcam

(ii) install the appropriate software for the webcam

(iii) connect the webcam to the PC

(iv) select an IM application

(v) download the software for the IM application

(vi) create an email account and select a userid for use with that account

(vii) create an account for the IM service and register the email account

(viii) find out the userids of the other users with whom the user wishes to communicate, and

(ix) add these userids to the buddy list of the IM application just in preparation of a later VIM call. At the time of actually making the call, the user will further have to:

(i) log in to the IM application

(ii) check the buddy list to see if certain users are logged on

(iii) initiate a conversation with the appropriate buddy

(iv) use the IM interface to launch the webcam for the video conversation and/or send the other user an invitation to view the user's webcam.

Further, it is to be noted that the users on the other end also need to perform several of these steps, even to simply view video being transmitted by another user, leave alone to transmit it themselves. It is easy to see how intimidating these numerous steps are for a novice. This makes it extremely difficult for two novices to set up for and start a video call session. Moreover, even for a technically savvy person, it is very difficult to get his less technically oriented friends and family members set up for and actually connected in a video call.

Thus there is thus a need for a simple and intuitive system and method for establishing a communication link with another user, which would allow non-technically oriented users to also easily set up for and engage in such communication. There is a further need for easy and seamless creation and use of such a communication link in the context of video IM.

### BRIEF SUMMARY OF THE INVENTION

The present invention is a system and method for simply and intuitively establishing and using a communication link with another user. Various embodiments of the present invention allow one or more non-technically oriented users to also easily set up for, and engage easily in a video call.

According to one aspect of the present invention, an application used over a network (e.g., the Internet) is seamlessly downloaded onto a user's machine. Further, the user is provided with an account which has already been created/registered with the application. In addition, the user's account is linked to at least one other account, and information for this other account is populated into the contacts for the user's account with the application. Correspondingly, information for the user's account is populated into the contacts from the other account. This providing of already created/registered accounts, and the linking of various accounts, permits easy and seamless communication between users.

In accordance with an aspect of the present invention, the application mentioned is a video IM application. In one embodiment, users simply plug their camera in, and the system seamlessly establishes a video calling session with a buddy's (e.g., family member's) camera installation on another PC across the internet. In one embodiment, the user simply clicks a buddy icon on her desktop to be connected in a video call to one or more buddies. In one embodiment, a group of buddies can be created, where a video conference call between two or more buddies in the group can be established. In one such embodiment, buddies from this buddy group can seamlessly join into any ongoing conversations.

In one embodiment of the present invention, a package including multiple webcams and multiple account cards can be purchased. Each account card includes information for an account already created/registered with a communication service (e.g., Skype). These multiple accounts are linked. Multiple users can each use one webcam and one account card. When the camera is installed, all necessary software (if any) for the camera as well as the communication service is downloaded and/or customized. The user can then simply present the account card to the camera, and the account information (such as userid and password) is recognized by the system. The user is then automatically logged into the communication service using this account information. A second linked account is automatically added to the first account as a buddy, a contact, etc. The user can then simply click on this buddy to connect to the second user.

In one embodiment of the present invention, a unique ID is embedded within the webcam itself. This unique ID is associated with account information for an account with a communication service. In one embodiment, the unique ID is included on a small device which can be plugged into or inserted into the webcam (e.g., a USB flash drive). In yet another embodiment, the unique ID and/or the account information is obtained over a network by, for example, clicking on a link to a website URL. In one embodiment, an additional account card is printable from a host.

The features and advantages described in this summary and the following detailed description are not all-inclusive, and particularly, many additional features and advantages will be apparent to one of ordinary skill in the art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

The invention has other advantages and features which will be more readily apparent from the following detailed description of the invention and the appended claims, when taken in conjunction with the accompanying drawing, in which:

FIG. 1 is a block diagram which provides an example of a system that two users can use to communicate with each other

FIG. 2 is a flowchart of a method in accordance with an embodiment of the present system.

FIG. 3 shows an example of an account card in accordance with an embodiment of the present invention.

FIG. 4 is a flowchart that illustrates the steps taken in accordance with an embodiment of the present invention.

FIG. 5A shows a screenshot of a UI in accordance with an embodiment of the present invention.

FIG. 5B shows a screenshot of a UI in accordance with an embodiment of the present invention.

FIG. 5C shows a screenshot of a UI in accordance with an embodiment of the present invention.

FIG. 5D shows a screenshot of a UI in accordance with an embodiment of the present invention.

FIG. 5E shows a screenshot of a UI in accordance with an embodiment of the present invention.

FIG. 6 is a screenshot of an icon that is placed on the user's desktop in accordance with an embodiment of the present invention.

FIG. 7A is a screen shot of an IM application UI that a user can use to start a communication in accordance with an embodiment of the present invention.

FIG. 7B is a screen shot of a UI that a user can use to start a communication in accordance with an embodiment of the present invention.

FIG. 8 shows a webcam in accordance with an embodiment of the present invention.

### DETAILED DESCRIPTION OF THE INVENTION

The figures (or drawings) depict a preferred embodiment of the present invention for purposes of illustration only. It is noted that similar or like reference numbers in the figures may indicate similar or like functionality. One of skill in the art will readily recognize from the following discussion that alternative embodiments of the structures and methods disclosed herein may be employed without departing from the principles of the invention(s) herein. It is to be noted that the following discussion relates to video, audio and/or still image data. For convenience, in some places “image” or other similar terms may be used in this application. Where applicable, these are to be construed as including any such data capturable by an image capture device. Further, it is to be noted that the term “camera” is used various times in the following discussion. Where applicable, this term includes various image capture devices such as, but not limited to, webcams, Personal Digital Assistants (PDAs), cell phones, portable media players, and so on.

Some of the following discussion relates to Video IM, and involves the use of webcams. However, it is to be noted that the present invention is not limited to such embodiments. In particular, embodiments of the present invention can be used to facilitate set up and use of communication between users using various other applications (e.g., email applications, etc.), and may involve exchange of any type of data (e.g., text alone, voice alone, text and image data, voice and image data, text, voice and image data, and so on).

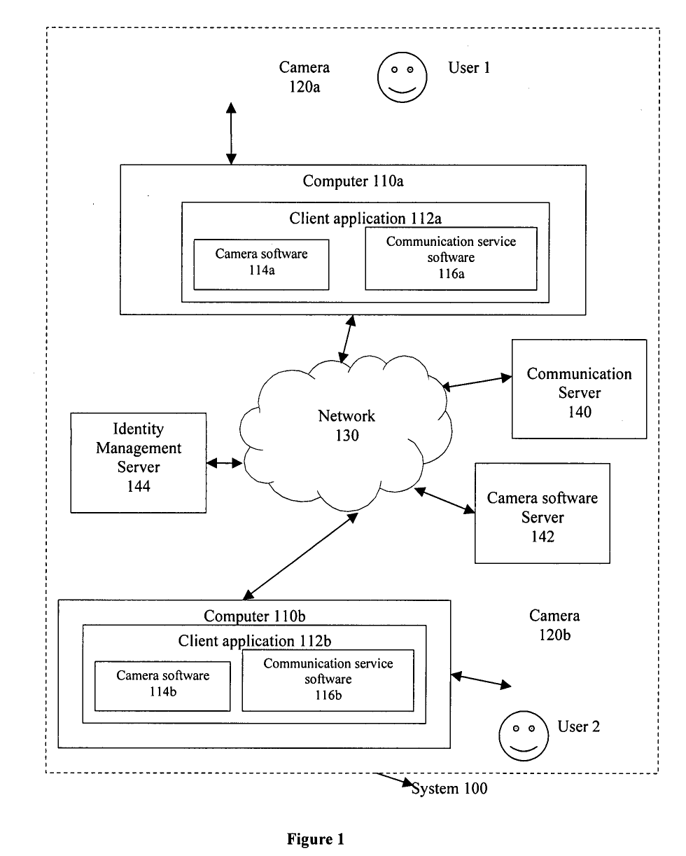

FIG. 1 is a block diagram which provides an example of a system 100 that two users, User 1 and User 2, can use to communicate with each other. System 100 comprises computer systems 110a and 110b, cameras 120a and 120b, network 130, and several servers 140, 142, and 144.

The computer systems 110a and 110b are conventional computer systems, that may each include a computer, a storage device, a network services connection, and conventional input/output devices such as, a display, a mouse, a printer, and/or a keyboard, that may couple to a computer system. The computer also includes a conventional operating system, an input/output device, and network services software. In addition, the computer includes a network service connection which includes those hardware and software components that allow for connecting to a conventional network service. For example, the network service connection may include a connection to a telecommunications line (e.g., a dial-up, digital subscriber line (“DSL”), a T1, or a T3 communication line). The host computer, the storage device, and the network services connection, may be available from, for example, IBM Corporation (Armonk, N.Y.), Sun Microsystems, Inc. (Palo Alto, Calif.), or Hewlett-Packard, Inc. (Palo Alto, Calif.). It is to be noted that the computer system can be any computing device capable of functionalities described herein, such as, but not limited to, gaming consoles, Personal Digital Assistants (PDAs), cell-phones, and so on.

Each computer system 110a, 110b also has a client application 112a, 112b on them. The client application 112a, 112b includes a camera software portion 114a, 114b, and a communication service software 116a, 116b. The communication service may be any communication service, such as an IM service, an email service, collaboration suites, etc. Examples of IM service include ICQ from ICQ, Inc., America OnLine Instant Messenger (AIM) from America Online, Inc. (Dulles, Va.), MSN® Messenger from Microsoft Corporation (Redmond, Wash.), Yahoo!® Instant Messenger from Yahoo! Inc. (Sunnyvale, Calif.), and Skype from Skype Technologies, S.A. (Luxemborg). Examples of email service include Google mail from Google (Mountain View, Calif.), Yahoo mail from Yahoo! Inc., Outlook Express from Microsoft Corp. Examples of collaboration suites include Lotus Notes from IBM (Armonk, N.Y.), and Outlook from Microsoft Corp.

The client application 112a, 112b also includes the user interface (UI) for the user to interact with the embodiments of the present invention. It is to be noted that one or more parts of the client application 112a, 112b (e.g., 114a, 114b, 116a, 116b) or the whole client application 112a, 112b itself need not be required to be on computer systems 110a, 110b in some embodiments. In such embodiments, the computer systems may be able to work simply with software on the servers 140, 142, 144 etc. through a browser for instance.

Cameras 120a and 120b are connected to the computer systems 110a and 110b respectively. In one embodiment cameras 120a and 120b are cameras connectable to computer systems 110a and 110b. QuickCam® webcams from Logitech, Inc. (Fremont, Calif.) are examples of cameras 120a and 120b.

The network 130 can be any network, such as a Wide Area Network (WAN) or a Local Area Network (LAN), or any other network. A WAN may include the Internet, the Internet 2, and the like. A LAN may include an Intranet, which may be a network based on, for example, TCP/IP belonging to an organization accessible only by the organization's members, employees, or others with authorization. A LAN may also be a network such as, for example, Netware™ from Novell Corporation (Provo, Utah) or Windows NT from Microsoft Corporation (Redmond, Wash.). The network 120 may also include commercially available subscription-based services such as, for example, AOL from America Online, Inc. (Dulles, Va.) or MSN from Microsoft Corporation (Redmond, Wash.). The network 120 may also be a home network, an Ethernet based network, a network based on the public switched telephone network, a network based on the Internet, or any other communication network. Any of the connections in the network 120 may be wired or wireless.

Servers 140, 142, and 144 are servers that each system 110a and 110b can communicate with over the network 130. Some or all of these servers are remote in one embodiment. Several other servers (not shown) may also be present. Server 140 is a communication server 140 for the communication service that the users rely on to communicate with each other. Examples of such communication services (e.g., IM services, email services, etc.) have been provided above. Server 142 is a camera software server. For instance, this server 142 may provide updated camera software to the computer systems 110a and 110b. Server 144 is an identity management server, which can identify the specific cameras 120a and 120b, based on unique product ids for instance. It is to be noted that one or more of the servers 140, 142, and 144 may be combined into a single server, and/or may be owned by a single source such as the assignee of the present application.

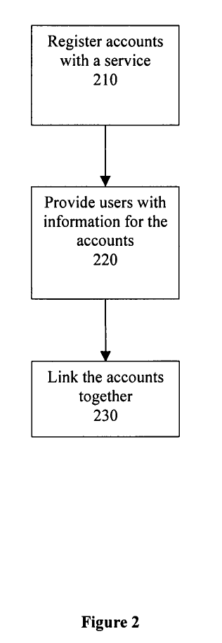

FIG. 2 is a flowchart of a method in accordance with an embodiment of the present system, which illustrates how accounts on a service are pre-provisioned and linked together in an easy and seamless manner. For purposes of this example, it is assumed that an IM service/application is used by the users to communicate with each other. However, various different services/applications (e.g., email applications etc.) can be used in accordance with embodiments of the present invention.

It can be seen from FIG. 2 that accounts are created and registered (step 210) with the IM service. In one embodiment, the account is created with a collaboration suite or with an email service (such as hotmail), and this account is registered with the IM service (e.g., MSN) In one embodiment, a userid and a password are chosen for each account. One or both of these can later be changed by a user if he/she so desires, and if the IM service allows such changes. In one embodiment, the creation and registration of the account is not done by the user. Instead, a registered account is provided to the user along with information about the account, as discussed below.

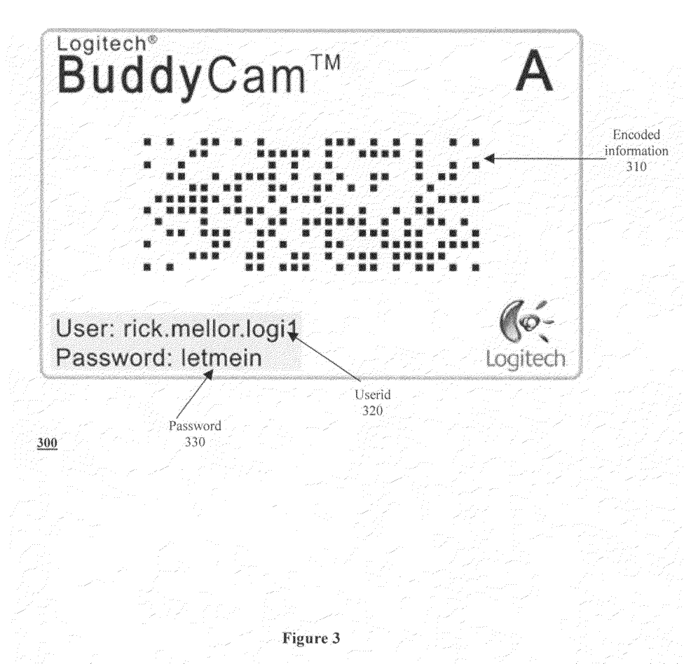

Users are provided (step 220) with information relating to these registered accounts. In one embodiment, a user is provided with a card which includes information about the pre-registered account. Such a card is described in more detail below with respect to FIG. 3. In another embodiment, such account information may be hard coded into a camera 120a. In one embodiment, the account information is contained in camera firmware. In one such embodiment, users are allowed to add to/write to camera memory, such that additional users can be added on to the “camera community”. In one embodiment, technology such as RFID is used for communicating such information. In yet another embodiment, a camera may have a sticker on it with the account information. In another embodiment, a physical device (such as a card) can have the information on it, and once the information is “shown” to the camera, the camera stores this information, so that the information is then within the camera. In still another embodiment, a service on a remote server can create the account information and transmit this information to the camera software. In one embodiment, this information can be transmitted via a URL link which the user can click on to be taken to a website with the userid and password information. In one embodiment, an email with the requisite information is sent to the user(s). In one embodiment, such an email includes a link on which the user can click to be shown the requisite information. In one embodiment, such information is printable from a host.

The accounts are linked together (step 230) in order to facilitate communication between the users. In one embodiment, this is done by populating the “Buddy list” of the IM application on one user's account, with the account information of the other user, and vice versa. For other applications, the accounts are linked together in different ways. For instance, in the case of an email application, such linking (step 230) is done in one embodiment by populating into the “Contacts” folder of one user, the information for the account of the other user.

It is to be noted that, for the sake of simplicity, the above example mentions two users. However, the present invention is not limited to any particular number of users. Embodiments of the present invention can be used to seamlessly connect numerous users together. For instance, various members of a family can be connected so that they can easily communicate with another member of the family, and/or with several members of the family simultaneously.

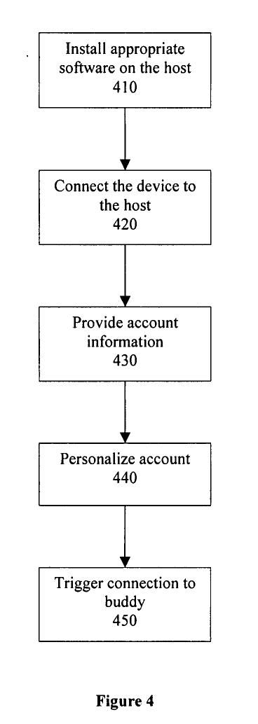

In some embodiments of the present invention, video calling is facilitated. An IM application is an example of an application that can be used for video calling. In one such embodiment, a user can purchase a pre-packaged bundle of several (for example, two) webcams. In one embodiment, the pre-packaged bundle also includes account cards—one for each camera in the bundle. It is thus easy for a user to purchase such a bundle, retain one webcam and account card for himself, and send the other webcam and account card to another user. This is discussed further with reference to FIG. 4.

It is to be noted that the account cards can be purchased, in one embodiment, separately from the webcams and/or the pre-packaged bundle. In one embodiment, a user can simply order cards online and get them mailed to himself and/or his one or more friends, family members and so on.

FIG. 3 shows an example of an account card 300 in accordance with an embodiment of the present invention. As can be seen from FIG. 3, each card 300 contains encoded information 310 which encodes a userid and a password for a pre-registered account. In one embodiment, the encoded information 310 is a data matrix. In addition, the card includes the userid 320 and the password 330, such that the user can read these. In one embodiment, the user can simply present the card 300 to the webcam during installation, so that the code value and password is automatically interpreted Based upon the encoded information 310, or the alphanumeric userid 320 and password 330. If for some reason optical recognition is not possible, the user may manually enter the information provided on the card as well.

In one embodiment, the card 300 is a wallet sized card. In one embodiment, the card 300 can have room on its back for an address and a stamp, and can be easily mailed to another user. In yet another embodiment, the card 300 is already pre-stamped for further convenience.

It is to be noted that a card is just an example of a physical object which can include userid and password information for a pre-registered account. Any physical object capable of including such information can be used. For instance, a flash drive adhering to the U3 specification from U3 LLC (Redwood City, Calif.) can be used which includes such userid and password information. In one embodiment, such a flash drive also includes executables for all the necessary software (such as software for the webcam, software for the IM application etc.), such that the flash drive can be plugged into virtually any suitable host machine, and the user can start an IM and/or VIM conversation with his buddy (or buddies) right away.

FIG. 4 is a flowchart that illustrates the steps taken in accordance with an embodiment of the present invention. In this embodiment, a purchaser purchases the bundled webcams and account cards mentioned above. For purposes of this discussion, let us assume that there are two webcams and two account cards 300 (one for each webcam) in the purchased bundle.

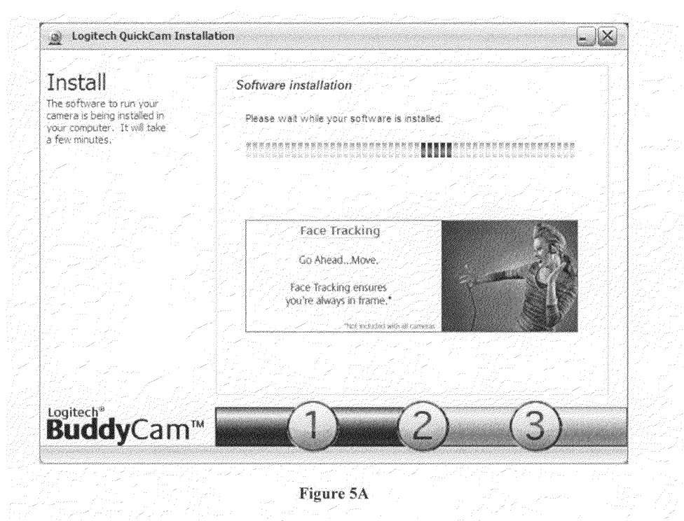

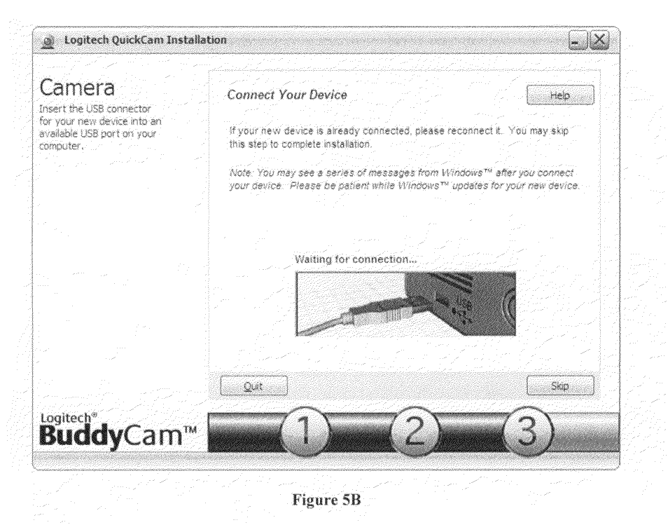

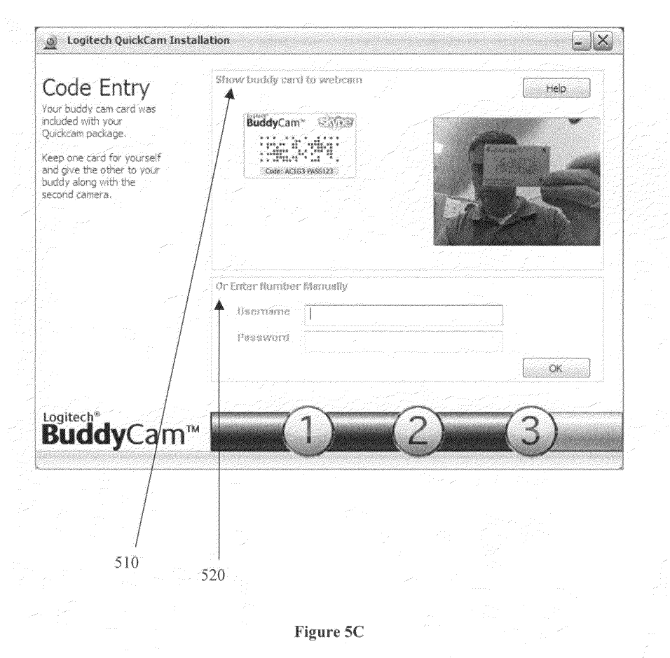

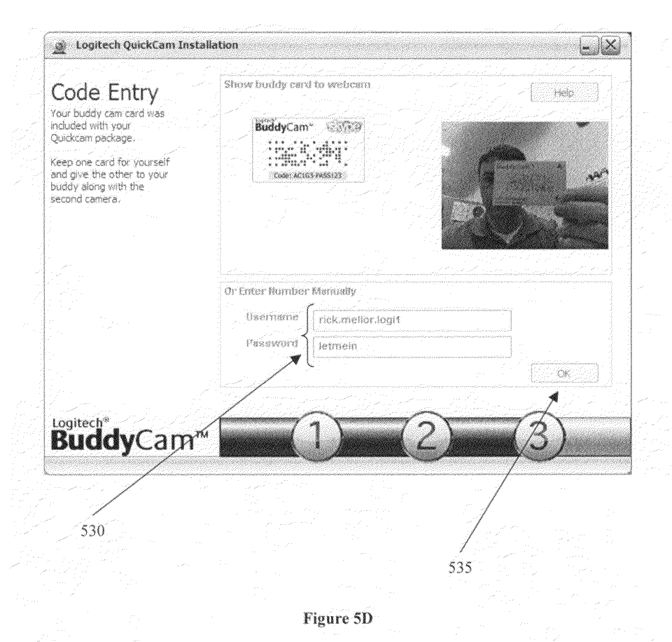

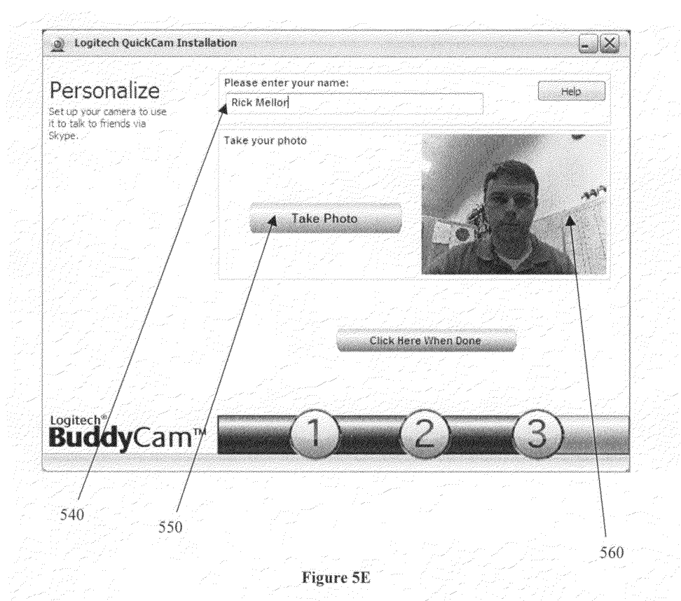

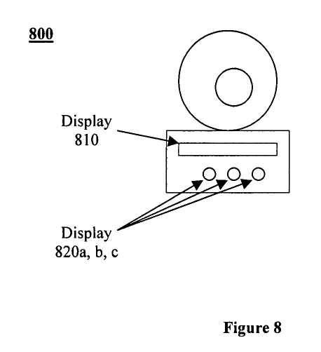

The appropriate software is installed (step 410) on to the host. As will be obvious to one of skill in the art, installation of some software may be needed as part of connecting the webcam to the machine. In one embodiment, each webcam may be accompanied by some software (e.g., on CDs included in the package, or on some type of internal or external memory accompanying the webcam, such as a flash drive.). In other embodiments, the address for a remote site (e.g., a URL) is included in the webcam. The remote site is contacted over a network, and the necessary software is downloaded on to the user's machine from this remote site. In one embodiment, the software can be run (e.g., as an ActiveX component) on remote site itself. In some of these embodiments, the camera can simply be taken and plugged into any machine, and software configuration can be initiated simply (e.g., with the press of a button on the camera to initiate the setup and/or the call). Some combination of the above scenarios is also possible. For instance, a CD may accompany the webcam, to install software onto the user's machine, and during this installation, a remote site (such as the camera software server 142 and/or the communication server 140) may be contacted to check for updated software. If such updated software exists, it is downloaded from the remote site (such as the camera software server 142). Further, if the service/application software needs to be downloaded on the user's machine, it is also seamlessly downloaded at this point. For instance, such service/application software may be bundled onto the CD itself. The user does not have to proactively download the service/application software (e.g., by going to the service provider's site and requesting a download). For some services (such as web-based email services), application software on the user's machine is not required. For some applications and/or implementations, some customization of the user interface (UI) of the application is performed. Such a situation is discussed below with reference to FIG. 8. If it is determined that the software is already installed on the user's machine, in one embodiment, some updating and/or customization of the UI is performed as needed. FIG. 5A shows a screenshot of a UI in accordance with an embodiment of the present invention, where the user is informed that required software is being installed on the host.

Referring again to FIG. 4, it can be seen that the user connects (step 420) the webcam to the host. As seen in FIG. 5B, this is done, in one embodiment, when the user is prompted to connect the webcam to the host. In one embodiment, the user first connects (step 420) the webcam, and then downloads and installs (step 410) the appropriate software from a remote website. In one such embodiment, the URL for the remote website is included with the webcam.

The user then provides (step 430) the account information to the host. FIG. 5C shows that in one embodiment, the user is instructed 510 to show the card 300 to the camera. Alternately, the user has the choice of entering the userid and the password manually 520. FIG. 5D shows that the userid and password fields are populated 530, either by the system by “seeing” the card 300, or manually by the user. When the user clicks on the Ok button 535, the system validates the userid and password.

Referring again to FIG. 4, it can be seen that the user then personalizes (step 440) his account. FIG. 5E is a screenshot of a UI in accordance with an embodiment of the present invention, which shows an example of how a user personalizes the card. The user enters his name 540. He can take a photo of himself using the camera, by clicking on the “Take Photo” button 550. In the window 560, the user can see a live video of himself prior to taking the picture. After the user clicks on “Take Photo”, the captured image of the user is seen in the window 560. In one embodiment, live video is again resumed in the window 560 after a certain period of time has elapsed.

It can be seen from FIG. 4 that the user then triggers (step 450) a call to his buddy. In one embodiment, the buddy needs to have received another webcam from the package, along with the other card. The buddy should have implemented similar steps, so that the call can be completed.

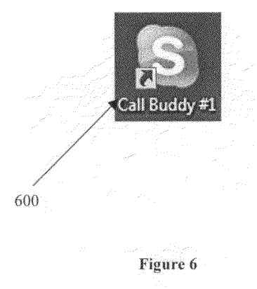

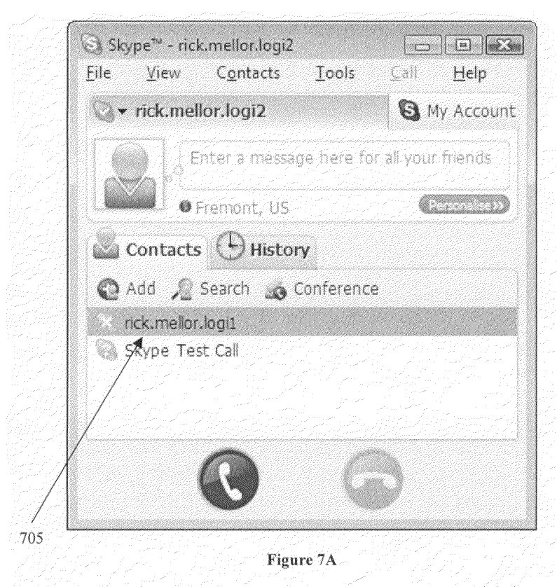

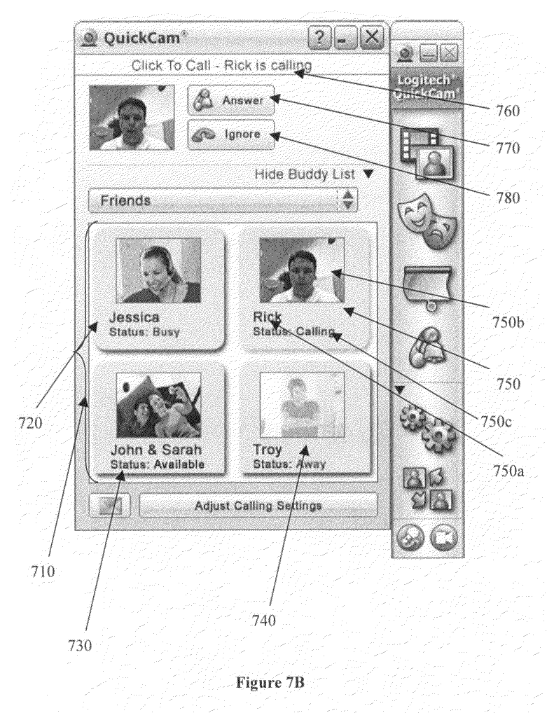

In one embodiment, after completing steps 410-440, a buddy call icon 600 is placed on the desktop of the host machine. An example of the buddy call icon 600 can be seen in FIG. 6. In one embodiment, a call to one or more buddies is triggered (step 450) by clicking on this icon 600. In another embodiment, a call to one or more buddies is triggered (step 450) by simply connecting the camera to the host. In yet another embodiment, a call to one or more buddies can be triggered (step 450) by opening the application (e.g., an IM application such as Skype) and clicking on the buddy name 705 as shown in FIG. 7A. In another embodiment, the user holds up the card 300 to the camera to initiate the call (after the initial set up is completed). In one embodiment, the buddy will then receive an invitation for the call, and can simply accept the invitation to start the conversation.

FIG. 7B provides another example of a UI in accordance with an embodiment of the present invention. In this screenshot, the user's buddy list 710 is populated with his various buddies. Let us assume that the buddies Jessica 720, John & Sarah 730, and Troy 740 were already on the user's buddy list 710. Now consider that Rick 750 is the user who was provided with the other webcam and account card as discussed above. The user's buddy list 710 is automatically revised to include Rick 750 in the buddy list. As can be seen from FIG. 7B, each buddy includes the buddy's name (e.g., 750a), the buddy's photo (e.g., 750b), and the buddy's status (e.g., 750c) such as busy, available, calling, etc. Further, the photo is presented differently in one embodiment, based upon the buddy's status. For instance, it can be seen the photo for Troy 740 appears faded out because the status for this buddy is “away”. In FIG. 7B, it can be seen that Rick is calling 760. The user can answer the call simply by clicking on the “Answer” button 770, or by pressing “Enter.” The user can ignore the call by clicking on the “Ignore” button 780.

It will be clear to one of skill in the art that the order of several of the above steps outlined in FIGS. 2 & 4 can be changed, several of the above steps can be performed simultaneously, and so on.

In one embodiment, instead of a package with two webcams and cards, the package may include several cards. The accounts associated with each of these cards are linked to all others in the package/set. The buddy list of each of these accounts will be populated with the remaining accounts. In such a scenario, all the buddies seen above in FIG. 7B (720 through 750) can be automatically populated. In one embodiment, in such a buddy group, some or all of these buddies can engage in a conference call. In one embodiment, other buddies in the group can join in seamlessly into an ongoing conversation.

In one embodiment, it is possible for a single user to have multiple accounts (e.g., by having multiple cards). The user may have different buddies (or buddy groups) associated with each of her accounts. For instance, a user may have one card for a family buddy group, and another card for a friends buddy group. In one embodiment, when the user holds up the first card to the camera, she triggers a call to one or more of her family members. When she holds up the other card to the camera, she triggers a call to one of more of her friends. Alternately, as discussed above, the user has different icons on her desktop, corresponding to her different buddy groups—for example, one icon for her family buddy group, and one icon for her friends buddy group.

It is to be noted that rather than purchasing a package including two (or more) cameras at the same time, a user may simply buy a single camera in accordance with an embodiment of the present invention. Another user may separately buy another camera, or the first user may buy a second camera later. In any case, in accordance with the present invention, the account associated with the second camera is linked to the account associated with the first camera. In one embodiment, this is done by providing the id of the first camera when purchasing the second camera. The second camera is then configured to link the account associated with it to the account associated with the first camera. In yet another embodiment, users may be able to purchase cards alone.

In one embodiment, if the purchaser purchases a single camera, he connects the camera, and then chooses to “add family member” button in the client application software. A remote server (e.g., server 144) collects credit card information from the purchaser, recipient's shipping address, and then automatically collects purchaser's unique camera ID from the software on the user's system. This unique camera ID is used to link the account associated with the purchaser's camera to the account that will be associated with the recipient's camera. Such a camera is then shipped to the recipient. When the recipient plugs in new camera, he can seamlessly connect to the purchaser as discussed above.

Regardless of the number of cameras purchased and set up for communication initially, in accordance with embodiments of the present invention, any user can add additional cameras to their “camera-community”. In one embodiment, this can be done through an “add family member” button available on the camera software.

As can be seen from the above discussion, in embodiments of the present invention, the user does not need to engage in any sign up process, separate downloads of service/application software (e.g., IM software), registration, selection of userids, etc. Further, the user does not need to log in anywhere, since the account is tied to the device (camera) itself, rather than to a specific user. The user's experience is therefore more analogous to a phone call than to an IM experience in terms of ease of placing the call. At the same time, the experience of the conversation itself is far superior to a phone call, since it involves high quality video as well as wideband audio. In addition, various effects possible in VIM can be introduced with embodiments in accordance with the present invention. Various such video effects are described in co-pending application Ser. No. 11/398,506, entitled “Real-time automatic facial feature replacement” filed on Apr. 4, 2006, and co-pending application Ser. No. 11/183,179 entitled “Facial Feature-Localized and Global Real-Time Video Morphing” filed on Jul. 14, 2005. Both of these applications are assigned to the assignee of the present application.

In one embodiment, the remote server, the service platform, and the video calling application are all hosted by a single entity, such as the assignee of the present invention.

In one embodiment of the present invention, a client server implementation occurs. The client software for the system provides the server with information regarding the camera that a user has connected to the system. When a paired (or linked) camera is connected, and the server is informed about that, the users are notified regarding the availability of a paired camera. Alternately, a connection between the paired cameras can be automatically initiated by the server.

FIG. 8 shows a webcam 800 in accordance with an embodiment of the present invention. This webcam includes a display 810 and buttons 820a, b and c. In one embodiment, the display 810 displays the caller id for an incoming call. In one embodiment, the display 810 also displays the current status of the user (e.g., in call, etc.). In one embodiment, the webcam 800 also has user buttons 820 a-c for answering incoming calls, initiating calls to different buddies/buddy groups etc. The communication application (e.g., IM application) is customized in such embodiments to interact with the webcam 800 directly. Such a webcam 800 further facilitates a communication experience for a user who is not familiar with the communication application itself.

It is to be noted that webcam 800 is only an example of a webcam that can be used in a system in accordance with an embodiment of the present invention. Other (for example conventional) webcams can also be used in accordance with embodiments of the present invention.

While particular embodiments and applications of the present invention have been illustrated and described, it is to be understood that the invention is not limited to the precise construction and components disclosed herein. For example, the account card discussed above is not necessary. For example, the accounts can be linked via hardware of the webcams. Further, the present invention is not limited to IM applications. Rather, embodiments of the present invention are applicable with any application where identities of different users need to be associated. Various other modifications, changes, and variations which will be apparent to those skilled in the art may be made in the arrangement, operation and details of the method and apparatus of the present invention disclosed herein, without departing from the spirit and scope of the invention as defined in the following claims.

What is claimed is:

1. A method for facilitating instant messaging (IM) communication between a first user and a second user, the method comprising:
providing the first user with an account registered with an IM service;
linking the account with a second account registered with the IM service; and
populating the buddy list of the first account with information for the second account, and the buddy list of the second account with information for the first account.

2. The method of claim 1, further comprising:
seamlessly installing software for the IM service on a host associated with the first user; and
automatically logging the first user in to the IM service.

3. The method of claim 1, further comprising:
providing the first user with information regarding the first account; and
providing the second user with information regarding the second account.

4. The method of claim 3, wherein the step of providing the first user with information regarding the first account comprises:
providing the user with a physical object including the information

5. The method of claim 4, wherein the physical object is one of a group consisting of a card and a flash drive.

6. The method of claim 3, wherein the step of providing the first user with information regarding the first account comprises:
embedding the information on a camera.

7. The method of claim 3, wherein the step of providing the first user with information regarding the first account comprises:
sending the first user a link to the information.

8. A method for facilitating video instant messaging (IM) conversation between a first user and a second user, the method comprising:
providing a first webcam and a second webcam; and
providing a first account with an IM service and a second account with the IM service, wherein the first account and the second account are linked.

9. The method of claim 8, further comprising:
providing a first card with information for the first account; and
providing a second card with information for the second account.

10. The method of claim 9, further comprising:
capturing the information on the first card via the first webcam.

11. The method of claim 8, further comprising:
allowing personalization of the first account.

12. The method of claim 11, wherein the personalization comprises:
receiving an image associated with the first user; and
receiving a name associated with the first user.

13. A method for facilitating communication between a first user and a second user using a communication service, the method comprising:
providing the first user with an account pre-registered with the communication service; and
linking the account with at least a second account pre-registered with the communication service.

14. The method of claim 13, wherein the communication service is an IM service.

15. The method of claim 14 further comprising:
populating the buddy list of the first account with information for the second account.

16. The method of claim 13, wherein the communication service is an email service.

17. The method of claim 16 further comprising:
populating the contacts folder of the first account with information for the second account.

18. A card for facilitating communication using a communication service, the card comprising:
encoded information based on a userid and a password for an account registered with the communication service;
the userid in alphanumeric characters; and
the password in alphanumeric characters.

19. The card of claim 18, wherein the encoded information is a data matrix.

20. The card of claim 18, wherein the card is presentable to a camera communicatively coupled to optical recognition software for recognizing the encoded information.

21. A package for facilitating video communication using a communication service, the package comprising:
a first webcam;
a second webcam;
a first card with information for a first account registered with the communication service, wherein the first card is for use with the first webcam;
a second card with information for a second account registered with the communication service, wherein the second card is for use with the second webcam, and wherein the first account and the second account are linked together.

22. A method for facilitating video communication between a first user and second user, the method comprising:
installing a first webcam on a host;
presenting a card to the webcam, the card containing information for an account with a communication service; and
initiating video communication with the second user by selecting an entry automatically populated into a buddy list for the communication service.
